(19) United States
(12) Patent Application Publication
(10) Pub. No.: US 2009/0172684 A1
(43) Pub. Date: Jul. 2, 2009

(54) SMALL LOW POWER EMBEDDED SYSTEM AND PREEMPTION AVOIDANCE METHOD THEREOF

(76) Inventors: Tae Ho HWANG, Seoul (KR); Yeon Kug MOON, Seoul (KR); Dong Sun KIM, Gyeonggi-do (KR); Kwang Ho WON, Gyeonggi-do (KR)

Correspondence Address: MCNEELY BODENDORF LLP, P.O. BOX 34175, WASHINGTON, DC, 20043, US

(21) Appl. No.: 12/193,875

(22) Filed: Aug. 19, 2008

(30) Foreign Application Priority Data
Dec. 26, 2007 (KR) 10-2007-137951

(51) Int. Cl. G06F 9/46; G06F 13/24; G06F 1/04

(52) U.S. Cl. 718/103; 713/500; 710/260

(57) ABSTRACT

Provided are a small low power embedded system and a preemption avoidance method thereof. A method for avoiding preemption in a small low power embedded system includes fetching and running a periodic atomic task from a periodic run queue, reducing any one of periodic atomic tasks or performing the change of a task after changing a field of the run periodic atomic task into a run standby state, according to a result value of the run of the periodic atomic task, fetching a sporadic atomic task from a sporadic run queue, and acquiring a system clock, running the fetched sporadic atomic task according to run time in the worst condition, and reducing any one of sporadic atomic tasks or performing the change of an event after a field of the run sporadic atomic task into a run standby state, according to a result value of the run of the sporadic atomic task.

### CROSS-REFERENCE TO RELATED APPLICATIONS

This application claims the benefit under 35 U.S.C. §119 to Korean Patent Application No. 10-2007-0137951, filed on Dec. 26, 2007 in the Korean Intellectual Property Office, the disclosure of which is incorporated herein by reference in its entirety.

### TECHNICAL FIELD

The following description relates to a low power embedded system and a preemption avoidance method thereof, and more particularly, to a small low power embedded system and a preemption avoidance method thereof which are capable of avoiding a preemption of tasks based on dual priority scheduling while securing the simultaneous operation of the tasks without using a stack memory.

### BACKGROUND

Sensor network nodes operate in small low power devices and at the same time may run software having a complicate structure such as a MAC/Network protocol. Moreover, a fast response is desired according to application in the control of hardware devices. To satisfy the opposed two aspects, it is desirable to have sensor network nodes with an optimized operating system having an efficient structure.

In recent years, an event-driven scheme and a multi-thread scheme are debated in a computing architecture field. The computer structures of small computing devices for a sensor network are implemented in TinyOS capable of performing the scheduling of the event-driven scheme having a simple structure due to the limitation of power management and memory requirement. The TinyOS performs first-in first-out (FIFO) based scheduling according to the event-driven scheme in a development environment by a preprocessor of nesC(network embedded systems C), has a small code size, and performs fast task switching. However, a run-to-completion used in the event driven scheme makes the efficient management of system resources difficult because a concurrency of a task is not secured.

To complement such limitations, an operating system driven in a multi-thread scheme that optimizes the conventional scheduling scheme of an operating system to sensor nodes has been implemented. MANTIS OS being an exemplary representative operating system driven in the multi-thread scheme operates a system in a thread based round-robin scheduling scheme capable of time sharing based on time-slice. The efficiency of the use of the system resources increases and priority preemption may be applied to real-time works by securing concurrency through such a structure.

Limitations may exist in a case where the multi-thread scheme is applied to the sensor node. In this case, the largest limitation is associated with a memory. In the implementation of the multi-thread scheme, a task stack occupies a large portion of the memory. Generally, it should be considered in terms of efficiency to allocate hundreds or more bytes stack by a task unit in 4˜8 Kbytes memory. The sensor node needs an amount size of memory for a material structure for MAC and Network and data such as a routing table, and also needs an amount size of memory for some application programs data. Accordingly, in a case where the multi-thread scheme is used in the sensor node, there may be limitation on a capacity of a memory.

Although a scheduling scheme by time-slice may increase the efficient use and concurrency of system resources, there may be limitation in that a response speed on interrupts or events may be slowed down.

In the power management of system, since it is desirable that the sensor node always maintain an immediate respondable state, limitation may exist in a case of minimizing power consumption in an inactive state.

### SUMMARY

Accordingly, according to an aspect, there is provided a small low power embedded system and a preemption avoidance method thereof that are capable of avoiding a preemption of tasks based on dual priority scheduling while securing the simultaneous operation of the tasks without using a stack memory.

According to another aspect, there is provided a small low power embedded system and a preemption avoidance method thereof that are capable of reducing the number of memories used in a system by avoiding a preemption of tasks based on dual priority scheduling while securing the simultaneous operation of the tasks without using a stack memory.

According to still another aspect, a small low power embedded system comprises a periodic run queue for registering one or more periodic atomic tasks, a sporadic run queue for registering one or more sporadic atomic tasks, one or more devices used for the run of the periodic atomic tasks and the sporadic atomic tasks, and a scheduler for running the periodic atomic tasks of the periodic run queue periodically, and running the sporadic atomic tasks of the sporadic run queue periodically, wherein the scheduler avoids the preemption of the tasks based on dual priority scheduling while securing the simultaneous operation of the tasks and runs the periodic atomic tasks and the sporadic atomic tasks.

The scheduler may fetch and run a periodic atomic task from the periodic run queue, and reduce any one of the periodic atomic tasks after changing a field of the run periodic atomic task into a run standby state when a result value of the run is greater than 0.

The scheduler may fetch and run a periodic atomic task from the periodic run queue, and change the periodic atomic task into a sporadic atomic task waiting a standby event when a result value of the run is not greater than 0.

The scheduler may fetch a sporadic atomic task from the sporadic run queue, acquire a system clock, and complete the run of a task when run time in the worst condition is not larger than remaining time until the generation of a system clock interrupt.

The scheduler may fetch a sporadic atomic task from the sporadic run queue, acquire a system clock, run the sporadic atomic task when run time in the worst condition is larger than remaining time until the generation of a system clock interrupt, and fetch a result value of the run.

The scheduler may reduce any one of the sporadic atomic tasks after changing a field of the run sporadic atomic task into a run standby state when the result value of the run of the sporadic atomic task is greater than 0, and change an original event into a standby event used for the run of the sporadic atomic tasks when the result value of the run of the sporadic atomic task is not greater than 0.

According to still another aspect, a method for avoiding preemption in a small low power embedded system, comprises fetching and running a periodic atomic task from a periodic run queue, reducing any one of periodic atomic tasks or performing the change of a task after changing a field of the run periodic atomic task into a run standby state, according to a result value of the run of the periodic atomic task, fetching a sporadic atomic task from a sporadic run queue, and acquiring a system clock, running the fetched sporadic atomic task according to run time in the worst condition, and reducing any one of sporadic atomic tasks or performing the change of an event after a field of the run sporadic atomic task into a run standby state, according to a result value of the run of the sporadic atomic task.

The fetching and running of the periodic atomic task may be performed fetching the periodic atomic task as a pointer of a task control block.

The reducing or changing of the periodic atomic task may comprise determining whether a result value of the run of the periodic atomic task is greater than 0, reducing any one of the periodic atomic tasks in the periodic run queue after changing the field of the run periodic atomic task into the run standby state when the result value of the run is greater than 0 as a result of the determination, and performing the change of the task when the result value of the run is not greater than 0 as a result of the determination.

The changing of the task may be performed changing a periodic atomic task into a sporadic atomic task waiting a standby event.

The acquiring of the system clock may comprise checking whether a sporadic run queue to run is in the sporadic run queue when a periodic atomic task to run is not in the periodic run queue, fetching the sporadic atomic task from the sporadic run queue and acquiring the system clock when the sporadic run queue to run is in the sporadic run queue as a result of the check, and completing the run of a task when the sporadic run queue to run is not in the sporadic run queue as a result of the check.

The method may further comprise fetching a sporadic atomic task as a pointer of a task control block.

The running of the sporadic atomic task may comprises determining whether run time in the worst condition is larger than remaining time until the generation of a system clock interrupt, completing the run of a task when the run time in the worst condition is not larger than the remaining time as a result of the determination, and running a sporadic atomic task and fetching a result value of the run when the run time in the worst condition is larger than the remaining time as a result of the determination.

The reducing of the sporadic atomic task or the performing of the change may comprise determining whether a result value of the run of the sporadic atomic task is greater than 0, reducing any one of the sporadic atomic tasks in the sporadic run queue after changing the field of the run sporadic atomic task into the run standby state when the result value of the run of the sporadic atomic task is greater than 0 as a result of the determination, and performing the change of the event when the result value of the run of the sporadic atomic task is not greater than 0 as a result of the determination.

The performing of the change may be performed changing an original event into a standby event used in the run of a sporadic atomic task.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram of a small low power embedded system according to an exemplary embodiment.

FIG. 2 is a flowchart illustrating a preemption avoidance method of a small low power embedded system according to an exemplary embodiment.

FIG. 3 illustrates a serialized access process of a small low power embedded system according to an exemplary embodiment.

FIG. 4 illustrates a dynamic serialization process of a small low power embedded system according to an exemplary embodiment.

Throughout the drawings and the detailed description, unless otherwise described, the same drawing reference numerals will be understood to refer to the same elements, features, and structures.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

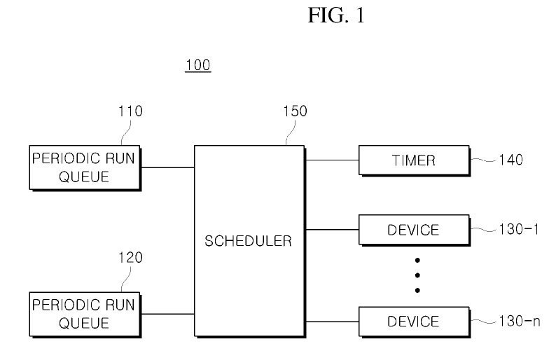

FIG. 1 shows a small low power embedded system 100 according to an exemplary embodiment.

Referring to FIG. 1, the small low power embedded system 100 comprises a periodic run queue (PRQ) 100, a sporadic run queue (SRQ) 120, a plurality of devices 130-1 to 130-n (n is 2 or more natural number), a timer 140, and a scheduler 150.

One or more periodic atomic tasks (PATs) are registered in the periodic run queue 110, wherein the periodic atomic tasks are triggered with time and are run by the scheduler 150.

One or more sporadic atomic tasks (SATs) are registered in the sporadic run queue 120, wherein the sporadic atomic tasks are triggered by an event and are run by the scheduler 150.

That is, an atomic task is classified as the periodic atomic task and the sporadic atomic task and is defined as different task control blocks. The atomic tasks operated by such an event are defined as a small code to which run to completion is secured without scheduling by the preemption of a central processing unit (CPU). According to an aspect, since a system implemented with the atomic tasks does not perform context switching by preemption, a stack memory may be shared. Thus, many advantages and/or improvements may be obtained in memory requirement.

The devices 130-1 to 130-n are used to run the periodic atomic task or the sporadic atomic task.

The timer 140 generates a system clock SYSCLK.

The scheduler 150 periodically runs the periodic atomic tasks of the periodic run queue 110 and the sporadic atomic tasks of the sporadic run queue 120. In this case, the scheduler 150 avoids a preemption of tasks based on dual priority scheduling while securing the simultaneous operation of the tasks and runs the tasks.

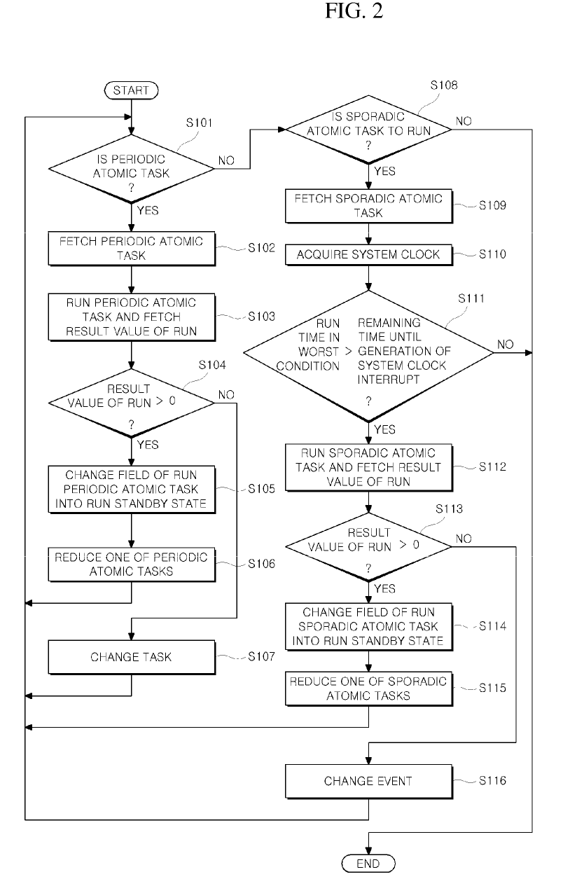

The preemption avoidance process of the small low power embedded system according to an exemplary embodiment will be described with reference to the accompanying flowchart of FIG. 2.

FIG. 2 is a flowchart illustrating a preemption avoidance method of a small low power embedded system according to an exemplary embodiment.

Referring to FIG. 2, the scheduler 150 checks whether a periodic atomic task to run is in the periodic run queue 110 in operation S101. Where a result of the check shows that the periodic atomic task to run is in the periodic run queue 110, the scheduler 150 fetches the periodic atomic task from the periodic run queue 110 in operation S102, wherein the periodic atomic task is a task searched by the scheduler 150. In this operation S102, the scheduler 150 fetches the periodic atomic task as a pointer of a task control block (RUNNABLE_PAT(p)).

The scheduler 150 runs a periodic atomic task (T(p).taskptr( )) and fetches a result value of the run (retval) in operation S103, and determines whether the result value of the run (retval) is greater than 0 in operation S104. Where a result of the determination shows that the result value of the run (retval) is greater than 0, the scheduler 150 changes a field of the run periodic atomic task (T(p).state) into a run standby state (WAIT) in operation S105. Furthermore, the scheduler 150 reduces any one of periodic atomic tasks in the periodic run queue 110 in operation S106. Herein, where the result value of the run (retval) is greater than 0, the periodic atomic task is normally run.

Where a result of the determination in operation S104 shows that the result value of the run (retval) is not greater than 0, the scheduler 150 changes a periodic atomic task Tᵢ₊₁₍ₐ₎ into a sporadic atomic task waiting a standby event e_{ready} in operation S107. That is, the scheduler 150 regards a periodic atomic task in the periodic run queue 110 as that the periodic atomic task has been run in the periodic run queue 100, moves the run periodic atomic task into the sporadic run queue 120, and allows the moved periodic atomic task to be run where the standby event e_{ready} is generated. Herein, where the result value of the run (retval) is not greater than 0, the periodic atomic task is not run normally.

Meanwhile, where a result of the check in operation S101 shows that the periodic run queue 110 does not have the periodic atomic task to run, the scheduler 150 checks whether a sporadic atomic task to run is in the sporadic run queue 120 in operation S108. Where a result of the check shows that the sporadic atomic task to run is not in the sporadic run queue 120, the scheduler 150 completes the run of a task.

Where a result of the check in operation S108 shows that the sporadic atomic task to run is in the sporadic run queue 120, the scheduler 150 fetches the sporadic atomic task from the sporadic run queue 120 in operation S109. In this operation S109, the scheduler 150 fetches the sporadic atomic task as a pointer of a task control block (RUNNABLE_SAT(s)).

The scheduler 150 acquires a system clock SYSCLK from the timer 140 in operation S110, and thereafter determines whether run time (T(s).wₛ) in the worst condition is larger than remaining time until the generation of a system clock interrupt CLKINT in operation S111, wherein the system clock interrupt CLKINT is generated for the acquired system clock SYSCLK. Where a result of the determination shows that the run time (T(s).wₛ) in the worst condition is not larger than the remaining time, the scheduler 150 completes the run of a task.

Where a result of the determination in operation S111 shows that the run time (T(s).wₛ) in the worst condition is larger than the remaining time, the scheduler 150 runs a sporadic atomic task (T(s).linkptr( )), fetches the result value of the run (retval) in operation S112, and determines whether the result value of the run (retval) is greater than 0 in operation S113. Where a result of the determination shows that the result value of the run (retval) is greater than 0, the scheduler 150 changes a field of the run sporadic atomic task (T(s).state) into the run standby state (WAIT) in operation S114. Furthermore, the scheduler 150 reduces any one of sporadic atomic tasks in the sporadic run queue 110 in operation S115. Herein, where the result value of the run (retval) is greater than 0, the sporadic atomic task is normally run.

Where a result of the determination in operation S113 shows that the result value of the run (retval) is not greater than 0, the scheduler 150 changes an original event (eₓ) into a standby event e_{ready}, and allows the sporadic atomic task to be run by the changed standby event e_{ready} in operation S116. Herein, where the result value of the run (retval) is not greater than 0, the sporadic atomic task is not run normally.

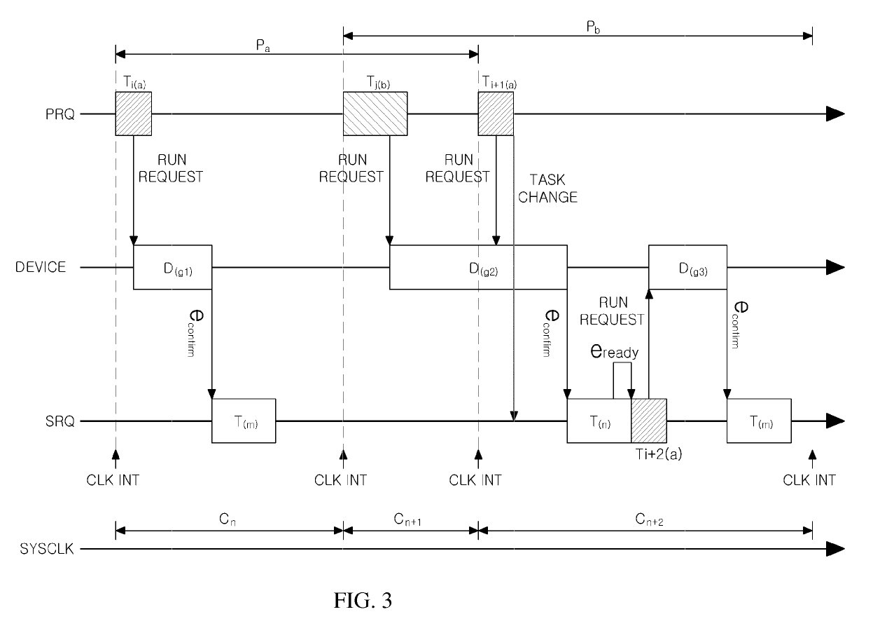

FIG. 3 illustrates a serialized access process of a small low power embedded system according to an exemplary embodiment. That is, FIG. 3 is an exemplary diagram for describing a task changing operation S107 of FIG. 2.

Referring to FIG. 3, after a task Tᵢ₍ₐ₎ and a task T_{j(b)} are run sequentially, a task Tᵢ₊₁₍ₐ₎ accesses a device D(g2), i.e., requests run to the device D(g2). At this point, where the device D(g2) is being used by the task T_{j(b)}, the task Tᵢ₊₁₍ₐ₎ returns 0. Furthermore, the scheduler 150 changes the periodic atomic task Tᵢ₊₁₍ₐ₎ into a task Tᵢ₊₂₍ₐ₎ waiting a standby event e_{ready}. Subsequently, where the operation of the device D(g2) is completed and the standby event e_{ready} is generated, the scheduler 150 runs the changed task Tᵢ₊₂₍ₐ₎ after the run of a sporadic atomic task T(n). In this case, the changed task Tᵢ₊₂₍ₐ₎ requests run to a corresponding device D(g3).

Where the system clock interrupt CLKINT is generated, the periodic atomic tasks Tᵢ₍ₐ₎, T_{j(b)} and Tᵢ₊₁₍ₐ₎ are run and request run to a corresponding device. Where operation by the run of a corresponding task is completed, the devices D(g1), D(g2) and D(g3) generate a confirm event e_{confirm} to inform that the operation of the devices D(g1), D(g2) and D(g3) is completed, and allow a corresponding sporadic atomic tasks T(m) and T(n) to be run.

As illustrated in FIG. 3, sporadic atomic tasks have constant run periods Pₐ and P_{b}. Furthermore, Cₙ, Cₙ₊₁ and Cₙ₊₂ indicate the generation period of the system clock interrupt CLKINT.

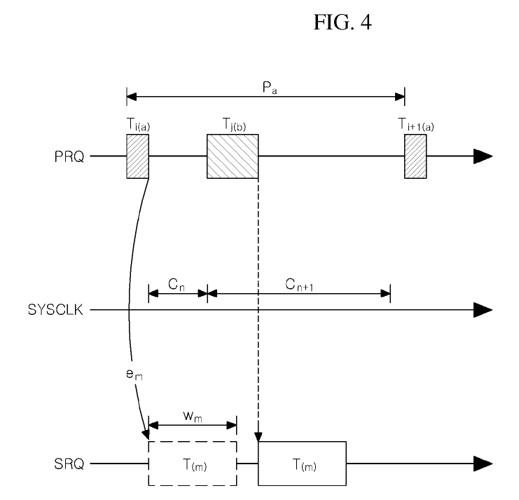

FIG. 4 illustrates a dynamic serialization process of a small low power embedded system according to an exemplary embodiment. That is, FIG. 4 is an exemplary diagram for describing operations S11 to S16 of FIG. 2.

Referring to FIG. 4, the periodic atomic task Tᵢ₍ₐ₎ generates an event eₘ for the run of the sporadic atomic task T(m). Where the scheduler 150 intends to run the sporadic atomic task T(m), the scheduler 150 determines whether run time wₘ in the worst condition is larger than remaining time until the generation of an nth system clock interrupt. Where a result of the determination shows that the run time wₘ in the worst condition is not larger than the remaining time until the generation of an nth system clock interrupt, the scheduler 150 runs the sporadic atomic task T(m) as it is. On the other hand, where a result of the determination shows that the run time wₘ in the worst condition is larger than the remaining time until the generation of an nth system clock interrupt, the scheduler 150 delays the run of the sporadic atomic task T(m) for the normal run of the periodic atomic task T_{i(a),} and runs the sporadic atomic task T(m) after the run of the periodic atomic task Tᵢ₍ₐ₎ is completed.

According to certain embodiments described above, a preemption of tasks may be avoided based on dual priority scheduling while securing the simultaneous operation of the tasks without using a stack memory. Accordingly, the number of memories used in a system may be reduced.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A small low power embedded system, comprising:
a periodic run queue for registering one or more periodic atomic tasks;
a sporadic run queue for registering one or more sporadic atomic tasks;
one or more devices used for the run of the periodic atomic tasks and the sporadic atomic tasks; and
a scheduler for running the periodic atomic tasks of the periodic run queue periodically, and running the sporadic atomic tasks of the sporadic run queue periodically,
wherein the scheduler avoids the preemption of the tasks based on dual priority scheduling while securing the simultaneous operation of the tasks and runs the periodic atomic tasks and the sporadic atomic tasks.

2. The system in claim 1, wherein the scheduler fetches and runs a periodic atomic task from the periodic run queue, and reduces any one of the periodic atomic tasks after changing a field of the run periodic atomic task into a run standby state when a result value of the run is greater than 0.

3. The system of claim 1, wherein the scheduler fetches and runs a periodic atomic task from the periodic run queue, and changes the periodic atomic task into a sporadic atomic task waiting a standby event when a result value of the run is not greater than 0.

4. The system of claim 1, wherein the scheduler fetches a sporadic atomic task from the sporadic run queue, acquires a system clock, and completes the run of a task when run time in the worst condition is not larger than remaining time until the generation of a system clock interrupt.

5. The system of claim 1, wherein the scheduler fetches a sporadic atomic task from the sporadic run queue, acquires a system clock, runs the sporadic atomic task when run time in the worst condition is larger than remaining time until the generation of a system clock interrupt, and fetches a result value of the run.

6. The system of claim 5, wherein the scheduler reduces any one of the sporadic atomic tasks after changing a field of the run sporadic atomic task into a run standby state when the result value of the run of the sporadic atomic task is greater than 0, and changes an original event into a standby event used for the run of the sporadic atomic tasks when the result value of the run of the sporadic atomic task is not greater than 0.

7. A method for avoiding preemption in a small low power embedded system, the method comprising:
fetching and running a periodic atomic task from a periodic run queue;
reducing any one of periodic atomic tasks or performing the change of a task after changing a field of the run periodic atomic task into a run standby state, according to a result value of the run of the periodic atomic task;
fetching a sporadic atomic task from a sporadic run queue, and acquiring a system clock;
running the fetched sporadic atomic task according to run time in the worst condition; and
reducing any one of sporadic atomic tasks or performing the change of an event after changing a field of the run sporadic atomic task into a run standby state, according to a result value of the run of the sporadic atomic task.

8. The method of claim 7, wherein the fetching and running of the periodic atomic task is performed fetching the periodic atomic task as a pointer of a task control block.

9. The method of claim 7, wherein the reducing or changing of the periodic atomic task comprises:
determining whether a result value of the run of the periodic atomic task is greater than 0;
reducing any one of the periodic atomic tasks in the periodic run queue after changing the field of the run periodic atomic task into the run standby state when the result value of the run is greater than 0 as a result of the determination; and
performing the change of the task when the result value of the run is not greater than 0 as a result of the determination.

10. The method of claim 9, wherein the changing of the task is performed changing a periodic atomic task into a sporadic atomic task waiting a standby event.

11. The method of claim 7, wherein the acquiring of the system clock comprises:
checking whether a sporadic run queue to run is in the sporadic run queue when a periodic atomic task to run is not in the periodic run queue;
fetching the sporadic atomic task from the sporadic run queue and acquiring the system clock when the sporadic run queue to run is in the sporadic run queue as a result of the check; and
completing the run of a task when the sporadic run queue to run is not in the sporadic run queue as a result of the check.

12. The method of claim 11, wherein the method further comprises fetching a sporadic atomic task as a pointer of a task control block.

13. The method of claim 7, wherein the running of the sporadic atomic task comprises:
determining whether run time in the worst condition is larger than remaining time until the generation of a system clock interrupt;
completing the run of a task when the run time in the worst condition is not larger than the remaining time as a result of the determination; and
running a sporadic atomic task and fetching a result value of the run when the run time in the worst condition is larger than the remaining time as a result of the determination.

14. The method of claim 7, wherein the reducing of the sporadic atomic task or the performing of the change comprises:
determining whether a result value of the run of the sporadic atomic task is greater than 0;
reducing any one of the sporadic atomic tasks in the sporadic run queue after changing the field of the run sporadic atomic task into the run standby state when the result value of the run of the sporadic atomic task is greater than 0 as a result of the determination; and
performing the change of the event when the result value of the run of the sporadic atomic task is not greater than 0 as a result of the determination.

15. The method of claim 14, wherein the performing of the change is performed changing an original event into a standby event used in the run of a sporadic atomic task.
